(19) United States
(12) Patent Application Publication
(10) Pub. No.: US 2016/0034904 A1
(43) Pub. Date: Feb. 4, 2016

(54) DETERMINING A POLICY CHANGE FOR AN OUTCOME RELATED TO AN OPPORTUNITY

(71) Applicant: International Business Machines Corporation, Armonk, NY (US)

(72) Inventors: Jorge A. Arroyo, Carmel, IN (US); Stephen P. Kruger, Dublin (IE); Patrick J. O'Sullivan, Dublin (IE); Luciano Silva, Apex, NC (US)

(21) Appl. No.: 14/709,181

(22) Filed: May 11, 2015

Related U.S. Application Data
(63) Continuation of application No. 14/450,063, filed on Aug. 1, 2014.

(51) Int. Cl. G06Q 30/00; G06F 17/30; G06Q 30/02

(52) U.S. Cl. CPC G06Q 30/01; G06Q 30/0201; G06F 17/30424

(57) ABSTRACT

Determining a policy change for an outcome related to an opportunity includes monitoring factors and outcomes associated with opportunities stored in a customer relationship management (CRM) system, extracting the factors and the outcomes associated with the opportunities stored in the CRM system into a queryable database, analyzing, via a queryable database, the factors and the outcomes associated with the opportunities to identify patterns related to the outcomes of the opportunities, and determining, based on the patterns related to the outcomes of the opportunities, a policy change to improve the outcomes related to the opportunities.

### BACKGROUND

The present invention relates to determining a policy change for an outcome, and more specifically, to determining a policy change for an outcome related to an opportunity.

A customer relationship management (CRM) system uses techniques and methods to gather, organize, automate, and synchronize sales, for marketing, customer service, and technical support. This information is stored in the CRM system's memory. Further, this information is retrieved from the CRM system's memory and analyzed to allow a company to better target various customers.

### BRIEF SUMMARY

A method for determining a policy change for an outcome related to an opportunity includes monitoring factors and outcomes associated with opportunities stored in a customer relationship management (CRM) system, extracting the factors and the outcomes associated with the opportunities stored in the CRM system into a queryable database, analyzing, via a queryable database, the factors and the outcomes associated with the opportunities to identify patterns related to the outcomes of the opportunities, and determining, based on the patterns related to the outcomes of the opportunities, a policy change to improve the outcomes related to the opportunities.

A system for determining a policy change for an outcome related to an opportunity includes a monitoring engine to monitor factors and outcomes associated with opportunities stored in a CRM system, an extracting engine to extract the factors and the outcomes associated with the opportunities stored in the CRM system into a queryable database, an applying engine to apply a weight to the factor, the outcome, an analyzing engine to analyze, via the queryable database, the factors and the outcomes associated with the opportunities to identify patterns related to the outcomes of the opportunities, and a determining engine to determine, based on the patterns related to the outcomes of the opportunities, a policy change to improve the outcomes related to the opportunities.

A computer program product includes a computer readable storage medium, the computer readable storage medium having computer readable program code embodied therewith. The computer readable program code having computer readable program code to extract factors and outcomes associated with opportunities stored in a CRM system into a queryable database, apply a weight to the factors and the outcomes, analyze, via the queryable database, the factors and the outcomes associated with the opportunities to identify patterns related to the outcomes of the opportunities, and determine, based on the patterns related to the outcomes of the opportunities, a policy change to improve the outcomes related to the opportunities.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for determining a policy change for an outcome related to an opportunity, according to one example of principles described herein.

FIG. 2 is a diagram of an example of a system for determining a policy change for an outcome related to an opportunity, according to one example of principles described herein.

FIG. 3 is a flowchart of an example of a method for determining a policy change for an outcome related to an opportunity, according to one example of principles described herein.

FIG. 4 is a flowchart of an example of a method for determining a policy change for an outcome related to an opportunity, according to one example of principles described herein.

FIG. 5 is a diagram of an example of a determining system, according to the principles described herein.

FIG. 6 is a diagram of an example of a determining system, according to the principles described herein.

Throughout the drawings, identical reference numbers designate similar, but not necessarily identical, elements.

### DETAILED DESCRIPTION

The present specification describes a method and system for determining a policy change for an outcome related to an opportunity, such that the policy change improves the outcome related to the opportunity.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the customer relationship management (CRM) system uses techniques and methods to organize, automate, and synchronize sales, for marketing, customer service, and technical support. This information that the CRM system gathers is stored in the CRM system's memory. Further, this information may be categorized as opportunities in the CRM system's memory. A user associated with a company may view the opportunities gather by the CRM system to allow the company to better target various customers.

Often, a CRM system includes thousands of opportunities. Further, some of the opportunities may be successful in generating profits for a business while other opportunities may be unsuccessful in generating profits for the business. To determine which opportunities are successful and/or unsuccessful in generating profits for the business, a user manually analyzes each of the opportunities. With thousands of opportunities in the CRM system, manually analyzing each of the opportunities can be a burdensome task for the user.

The principles described herein include a system and a method for determining a policy change for an outcome related to an opportunity Such a system and method includes monitoring factors and outcomes associated with opportunities stored in a CRM system, extracting the factors and the outcomes associated with the opportunities stored in the CRM system into a queryable database, analyzing, via a queryable database, the factors and the outcomes associated with the opportunities to identify patterns related to the outcomes of the opportunities, and determining, based on the patterns related to the outcomes of the opportunities, a policy change to improve the outcomes related to the opportunities. Such a method and system allows thousands of opportunities to be analyzed to determine what factors contributed to successful outcomes of an opportunity and what factors contributed to unsuccessful outcomes of an opportunity. As a result, the policy change improves the outcome related to the opportunity.

In the specification and appended claims, the term “factor” is meant to be understood broadly as an element associate with an opportunity that contributes to the outcome related to the opportunity. In one example, factors may be winning factors related to profit gains, losing factors related to profit losses, expenditures without improved sales, or combinations thereof. Further, factors associated with the opportunities may include factors such as products sold, sellers, customers, opportunity management, locations, currency, technology, timing, effort spent, costs, return on investment (ROI), other factors, or combinations thereof.

In the specification and appended claims, the term “outcome” is meant to be understood broadly as a determination whether an opportunity is successful or unsuccessful. For example, outcomes may include success based on obtained sales, failure based on missed sales, futile sales, other outcomes, or combinations thereof.

In the specification and appended claims, the term “policy change” is meant to be understood broadly as a change in a factor for an opportunity that results in a change for an outcome. In one example, a policy change may include changing the timing for an opportunity.

In the specification and appended claims, the term “weight” is meant to be understood broadly as a mechanism used to influence the analysis of the factors, outcomes, or combinations thereof. In one example, a weight is applied to the factors, the outcomes, or combinations thereof. Further, a weight may be symbolic such as low medium, or high. In another example, a weight may be a range such as 0 to 10, 0 indicating no weight and 10 indicating the greatest weight to be applied to the factors, outcomes, or combinations thereof.

In the specification and appended claims, the term “opportunities” is meant to be understood broadly as a complex record structure in a database, in which each of the opportunities captures a number of fields of metadata. In one example, the opportunities may include a business's sales and/or interaction with current customers, future customers, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

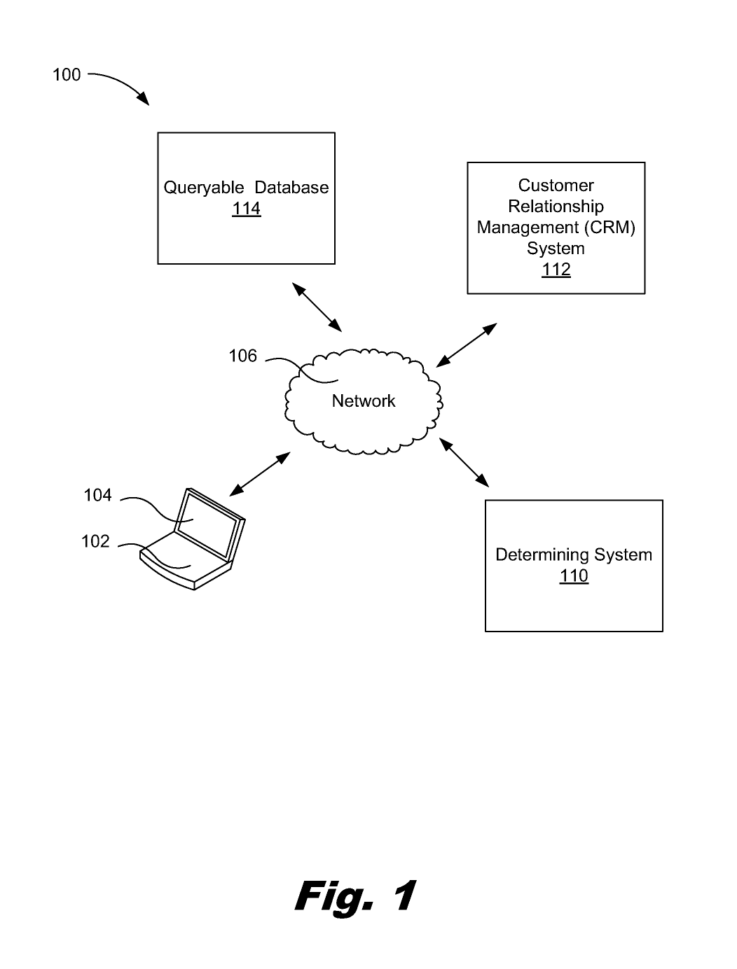

FIG. 1 is a diagram of an example of a system for determining a policy change for an outcome related to an opportunity, according to one example of principles described herein. As will be described below, a determining system is in communication with a network to monitor factors and outcomes associated with opportunities stored in a CRM system. The determining system extract the factors and the outcomes associated with the opportunities stored in the CRM system into a queryable database. Further, the determining system analyzes, via the queryable database, the factors and the outcomes associated with the opportunities to identify patterns related to the outcomes of the opportunities. The determining system further determines, based on the patterns related to the outcomes of the opportunities, a policy change to improve the outcomes related to the opportunities.

As illustrated in FIG. 1, the system (100) includes a CRM system (112). As mentioned above, the CRM system (112) uses techniques and methods to gather, organize, automate, and synchronize sales, for marketing, customer service, and technical support. This information is stored in the CRM system's memory. Further, this information is retrieved from the CRM system's memory and analyzed to allow a company to better target various customers.

As illustrated in FIG. 1, the system (100) includes a determining system (110). The determining system (110) monitor factors and outcomes associated with opportunities stored in a CRM system (112). In one example, the factors and the outcomes may be metadata that is related to the opportunities.

The determining system (110) extract the factors and the outcomes associated with the opportunities stored in the CRM system (112) into a queryable database (114). In one example, the queryable database (114) may be best suited to analyze the opportunities stored in a CRM system (112).

Further, the determining system (110) analyzes, via the queryable database (114), the factors and the outcomes associated with the opportunities to identify patterns related to the outcomes of the opportunities. As will be described below the patterns may be associated with the factors and the outcomes for the opportunities to determine if the opportunities are successful or unsuccessful.

The determining system (110) further determines, based on the patterns related to the outcomes of the opportunities, a policy change to improve the outcomes related to the opportunities. In one example, the policy change may be displayed to a user a user via a display (104) on a user device (102). Such a system allows thousands of opportunities to be analyzed to determine what factors contributed to successful outcomes of an opportunity and what factors contributed to unsuccessful outcomes of an opportunity. As a result, the policy change improves the outcome related to the opportunity. More information about the determining system (110) will be described in later parts of this specification.

While this example has been described with reference to the determining system being located over the network, the determining system may be located in any appropriate location. For example, the determining system may be located in a user device, a database, a CRM system, other locations, or combinations thereof.

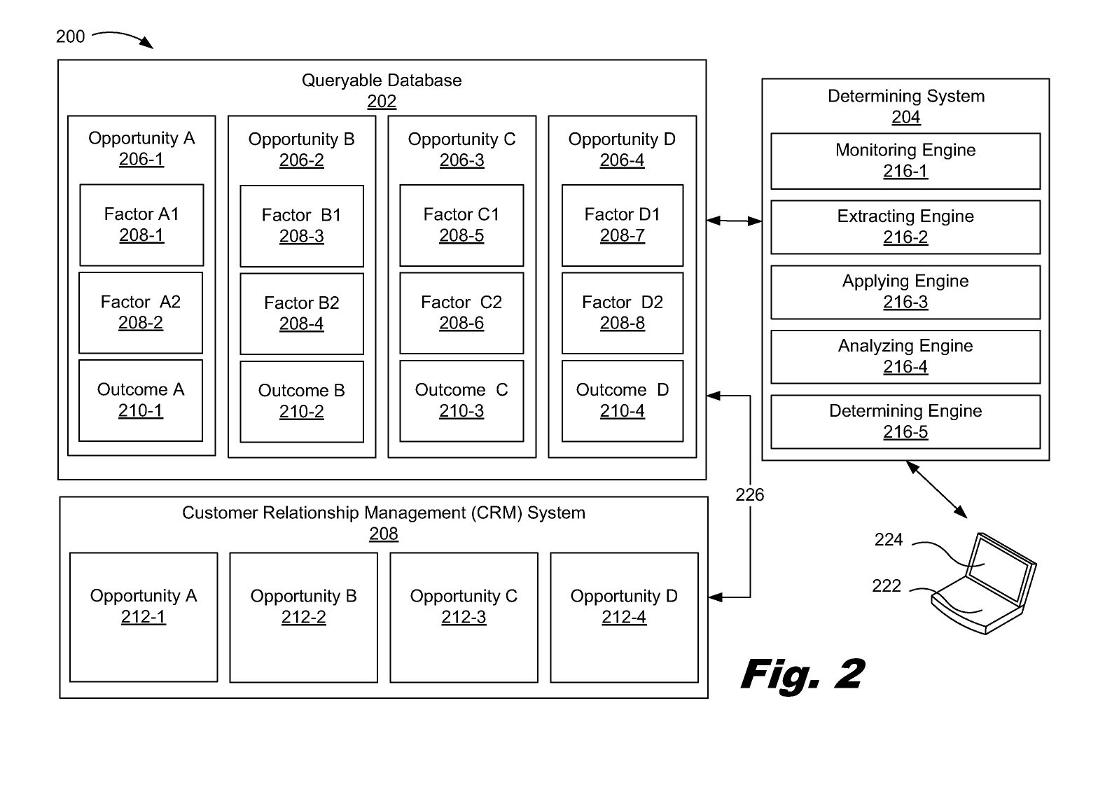

FIG. 2 is a diagram of an example of a system for determining a policy change for an outcome related to an opportunity, according to one example of principles described herein. As mentioned above, a determining system is in communication with a network to monitor factors and outcomes associated with opportunities stored in a CRM system. The determining system extract the factors and the outcomes associated with the opportunities stored in the CRM system into a queryable database. Further, the determining system analyzes, via the queryable database, the factors and the outcomes associated with the opportunities to identify patterns related to the outcomes of the opportunities. The determining system further determines, based on the patterns related to the outcomes of the opportunities, a policy change to improve the outcomes related to the opportunities.

As illustrated in FIG. 2, the system (200) includes a CRM system (208). The CRM system (208) is used as a model for managing a business's interactions with current and future customers. The CRM system (208) uses techniques and methods to organize, automate, and synchronize sales, for marketing, customer service, and technical support. In one example, the CRM system (208) may be a classical CRM system that monitors sources such as current customers and potentially future customers to gather information to better target various customers. The classical CRM system traditionally includes a one-way communication between a business and the customer.

In another example, the CRM system (208) may be a social CRM system that monitors sources such as social media sources. In this example, the social CRM system's strategy is based around customer engagement and interactions, with transactions being a byproduct. In one example, the Social CRM system may use a philosophy and a business strategy, supported by a technology platform, business rules, workflow, processes and social characteristics, designed to engage the customer in a collaborative conversation in order to provide mutually beneficial value in a trusted and transparent business environment. Further, the social CRM system includes applications in marketing, customer service and sales, including peer-to-peer customer support, idea management, market research, product launch, brand reputation management.

In this example, the social CRM system is a back-end process and system for managing customer relationships and data in an efficient and process-centric way. The social CRM system is able to understand the business's challenges that are to be solved and then solve the business's challenges. Further, the social CRM system may be one component of developing a social or collaborative business, both internally and externally.

As illustrated in FIG. 2, the information that the CRM system (208) gathers is stored as opportunities (212). As mentioned above, the opportunities (212) may be a complex record structure in a database, in which each of the opportunities (212) captures a number of fields of metadata. In one example, the opportunities (212) may include a business's sales and/or interaction with current customers, future customers, or combinations thereof. As illustrated, the CRM system (208) includes opportunity A (212-1), opportunity B (212-2), opportunity C (212-3), and opportunity D (212-4).

As illustrated in FIG. 2, the system (200) includes a determining system (204). The determining system (204) includes a monitoring engine (216-1), an extracting engine (216-2), an applying engine (216-3), an analyzing engine (216-4), and a determining engine (216-5). The engines (216) refer to a combination of hardware and program instructions to perform a designated function. Each of the engines (216) may include a processor and memory. The program instructions are stored in the memory and cause the processor to execute the designated function of the engine.

The monitoring engine (216-1) monitors factors and outcomes associated with the opportunities (212) stored in a CRM system (208). In one example, the monitoring engine (216-1) monitors all factors and all outcomes associated with the opportunities (212) stored in a CRM system (208). In another example, the monitoring engine (216-1) monitors specific factors and specific outcomes associated with the opportunities (212) stored in a CRM system (208).

The extracting engine (216-2) extracting the factors and the outcomes associated with the opportunities (212) stored in the CRM system (208) into a queryable database (202) as illustrated by arrow 226. As illustrated the queryable database (202) includes factors (208) and outcomes (210) that are associated with the opportunities (206) that have been extracted from the CRM system (208). For example, opportunity A (206-1) in the queryable database (202) includes factor A1 (208-1), factor A2 (208-2) and outcome A (210-1). Opportunity B (206-2) in the queryable database (202) includes factor B1 (208-3), factor B2 (208-4) and outcome B (210-2). Opportunity C (206-3) in the queryable database (202) includes factor C1 (208-5), factor C2 (208-6) and outcome C (210-3). Further, opportunity D (206-4) in the queryable database (202) includes factor D1 (208-7), factor D2 (208-8) and outcome D (210-4).

As mentioned above, the determining system (204) includes the applying engine (216-3). The applying engine (216-3) applies a weight to the factors (208) and the outcome (210). In one example, a weight may be a mechanism used to influence the analysis of the factors (208), outcomes (210), or combinations thereof. Further, a weight may be symbolic such as low medium, or high. In another example, a weight may be a range such as 0 to 10, 0 indicating no weight and 10 indicating the greatest weight to be applied to the factors, outcomes, or combinations thereof. In one example, the weight may be applied by a user via a user device (222). In this example, the user device (222) may include a display (224) that displays a user interface (UI). The UI allows the user to apply a weight to specific factors, specific outcomes, or combinations thereof.

The analyzing engine (216-4) analyzes, via the queryable database (202), the factors (208) and the outcomes (210) associated with the opportunities (206) to identify patterns related to the outcomes (210) of the opportunities (206). In one example, data mining may be used to analyze, via the queryable database (202), the factors (208) and the outcomes (210) associated with the opportunities (206) to identify patterns related to the outcomes (210) of the opportunities (206). For example, the analyzing engine (216) may analyze opportunity B (206-1) to identify a pattern such as Factor B1 (208-3) is to be applied to opportunity B (206-2) before Factor B2 (208-4) is to be applied to opportunity B (206-2).

The determining engine (216-5) determines, based on the patterns related to the outcomes of the opportunities, a policy change to improve the outcomes related to the opportunities. In one example, the policy change may be to change the timing for opportunity A (206-1) such that the timing will improve outcome A (210-1).

An overall example will now be described with reference to FIG. 2. The determining system (204) decomposes the artifacts, such as factors and outcomes, associated with the opportunities (208) of an existing CRM system (208) via the monitoring engine (216-1). The determining system (204) loads the outcomes and factors into the queryable database (202) via the extracting engine (216-2). In this example, the queryable database (202) is optimized for data mining to allow the determining system (204) to extract, group and generalize that information in a way which allows the determining system (204) to the compare it to existing CRM artifacts.

The queryable database (202) may contain several well-known CRM indicators and artifacts. For example, the determining system (204) can extract from the opportunities (216-2) content such as the products sold, who sold them, who managed the opportunity, the currency amounts, the customers involved, other content, or combinations thereof.

The determining system (204) correlates a plurality of successful and unsuccessful opportunities and infers the underlying ingredients to the success or lack of success of the opportunities. In one example, this may include a personality or plurality of personalities, products and versions involved and the inter-relationship at play between these in the sales solution and/or opportunity, customers involved and historical pattern in terms of these and other customers. This allows the determining system (204) to generate analytics to surface information about scorecard and/or sales opportunity that have outcomes that are winners and losers by asking questions such as for product A or industry A, who are the people or products who are involved in the sales/opportunity team that usually win? Alternatively, for product A or industry A, who are the people or products who are involved in the sales and/or opportunity team that usually lose? In one example, the determining system (204) may accomplish this via the analyzing engine (216-4).

The determining system (204) can apply geographical data that provides insight into who to engage or to pull from the opportunity team to maximize winning chances and minimize risks of loss. The determining system (204) may do this by providing a list of people as recommended experts or consultants for a high-visibility/-value opportunity via the determining engine (216-5). The risk profile can be applied to not only at people, but also products and technology combinations.

The determining system (204) could query failed opportunities to analyses why they failed with a view to provide recommendations on potential future opportunities and/or leads not yet in the system, generate alerts on existing high-value opportunities with high probability of loss, list opportunities with high probability of winning for support finance and/or revenue forecasts. In one example, the determining system (204) may accomplish this via the analyzing engine (216-4).

The determining system (204) could further query the monetary value of an opportunity (206) and cross-check that the team profile has an appropriate level of team members. Based on this information, the determining system (204) could bring in more senior members, raise the profile of the opportunity (206) to execs, and abandon the opportunity (206) due to a typical pattern of failure in non-core markets, allowing better focus of teams on revenue generating sources. In one example, the determining system (204) may accomplish this via the determining engine (216-5).

Further, data mining may aid the determining system (204) in other potential criteria contributing to the success or failure of an opportunity (206). The potential criteria contributing to the success or failure of an opportunity (206) may include timing, geography, products, other potential criteria, or combinations thereof.

In one example, the determining system (204) is concerned with the automated analysis of historical CRM artifacts and data in order to extract patterns of success or failure in past sales opportunities along with the inter-correlation of mined data to derive accurate results. Weighting factors and bias in the underlying CRM opportunity and social graph tree also influence relevance in these results. Then such identified patterns can be applied to score and risk profile future or open opportunities. For example, patterns identified by the analyzing system (216-4) can then be applied to a score and risk profile for the opportunities (206). Being able to compare CRM artifacts is significant to identify repeatable solutions, or conversely repeatable errors, allowing a manager to identify such patterns early enough in the CRM artifact lifecycle to be able to ensure or change a policy to improve an outcome of an opportunity (206).

As a result, the determining system (204) is concerned with leveraging the rich meta data in the CRM system (208), to include weighting of the individuals and relationships that derived both successful and unsuccessful opportunities (206) and, more fundamentally, the broader information surrounding both successful and unsuccessful sales opportunities that can, in turn, be used to improve the success of the opportunities (206).

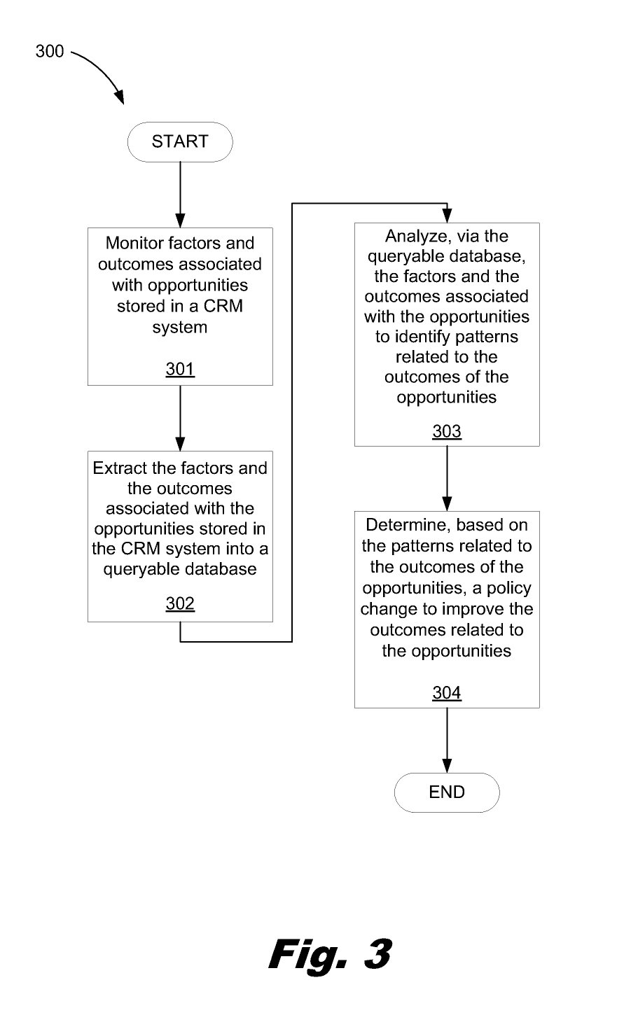

FIG. 3 is a flowchart of an example of a method for determining a policy change for an outcome related to an opportunity, according to one example of principles described herein. In one example, the method (300) may be executed by the integrating system (100) of FIG. 1. In other examples, the method (300) may be executed by other systems (i.e. system 200, system 500, and system 600). In this example, the method (300) includes monitoring (301) factors and outcomes associated with opportunities stored in a CRM system, extracting (302) the factors and the outcomes associated with the opportunities stored in the CRM system into a queryable database, analyzing (303), via a queryable database, the factors and the outcomes associated with the opportunities to identify patterns related to the outcomes of the opportunities, and determining (304), based on the patterns related to the outcomes of the opportunities, a policy change to improve the outcomes related to the opportunities.

As mentioned above, the method (300) includes monitoring (301) factors and outcomes associated with opportunities stored in a CRM system. In one example, the monitoring engine (502) monitors factors associated with the opportunities such as products sold, sellers, customers, opportunity management, locations, currency, technology, timing, effort spent, costs, ROI, other factors, or combinations thereof. In one example, the monitoring engine (502) monitors the outcomes associated with the opportunities such as success based on obtained sales, failure based on missed sales, futile sales, or combinations thereof.

In one example, the method (300) monitors factors and outcomes associated with, for example, opportunity A and opportunity B stored in a CRM system. In this example, opportunity A may be a relatively new opportunity in the CRM system. Further, opportunity B may be a relatively old opportunity in the CRM system. As will be described below, opportunity B may have similarities to opportunity A.

As mentioned above, the method (300) includes extracting (302) the factors and the outcomes associated with the opportunities stored in the CRM system into a queryable database. In one example, the queryable database may be best suited to analyze the opportunities stored in a CRM system. In keeping with the given example, the method (300) extracts the factors and the outcomes associated with opportunity A and opportunity B stored in the CRM system into a queryable database.

As mentioned above, the method (300) includes analyzing (303), via a queryable database, the factors and the outcomes associated with the opportunities to identify patterns related to the outcomes of the opportunities. In one example, an analyzing engine analyzes, via the queryable database, the factors and the outcomes associated with the opportunities to identify the patterns related to the outcomes of the opportunities by identifying the factors that are winning factors related to profit gains. In another example, the analyzing engine analyzes, via the queryable database, the factors and the outcomes associated with the opportunities to identify the patterns related to the outcomes of the opportunities further by identifying the factors that are losing factors related to profit loss. In still another example, the analyzing engine (506) analyzes, via the queryable database, the factors and the outcomes associated with the opportunities to identify the patterns related to the outcomes of the opportunities further by identifying the factors that are expenditures without improved sales.

In keeping with the given example, the method (300) analyzes, via the queryable database, the factors and the outcomes associated with opportunity A and opportunity B to identify patterns related to the outcomes of opportunity A and opportunity B. In one example, opportunity A's pattern may include portal version eight on operating system X, connection version four on platform Y, and middleware platform A. Further, opportunity B's pattern may indicate that opportunity B once included the same pattern as opportunity A. However, opportunity B encountered issues with this pattern. As a result, opportunity B's pattern may further indicate that middleware platform A was changed to middleware platform B.

As mentioned above, the method (300) includes determining (304), based on the patterns of the outcomes of the opportunities, a policy change to improve the outcomes related to the opportunities. In one example, the policy change may be to change the timing for an opportunity such that the timing will improve the outcome of the opportunity. Such a method (300) allows thousands of opportunities to be analyzed to determine what factors contributed to successful outcomes of an opportunity and what factors contributed to unsuccessful outcomes of an opportunity. As a result, the policy change improves the outcome related to the opportunity.

In keeping with the given example, the method (300) determines (304), based on the patterns of the outcomes of opportunity A and opportunity B, a policy change to improve the outcomes related to opportunity A. In this example, since opportunity A's pattern and opportunity B's pattern are similar, the method (300) determines a policy change, such as changing opportunity A's middleware platform A to middleware platform B improve the outcomes related to opportunity A. In this example, the method (300) may flag opportunity A as a bad path and recommend a corrective path for opportunity A based on opportunity B's pattern as described above.

As a result, the method (300) allows thousands of opportunities to be analyzed to determine what factors contributed to successful outcomes of an opportunity and what factors contributed to unsuccessful outcomes of an opportunity. As a result, the policy change improves the outcome related to the opportunity. Further, the method (300) may be utilized to see that a trajectory in one opportunity may be corrected by a history of another opportunity.

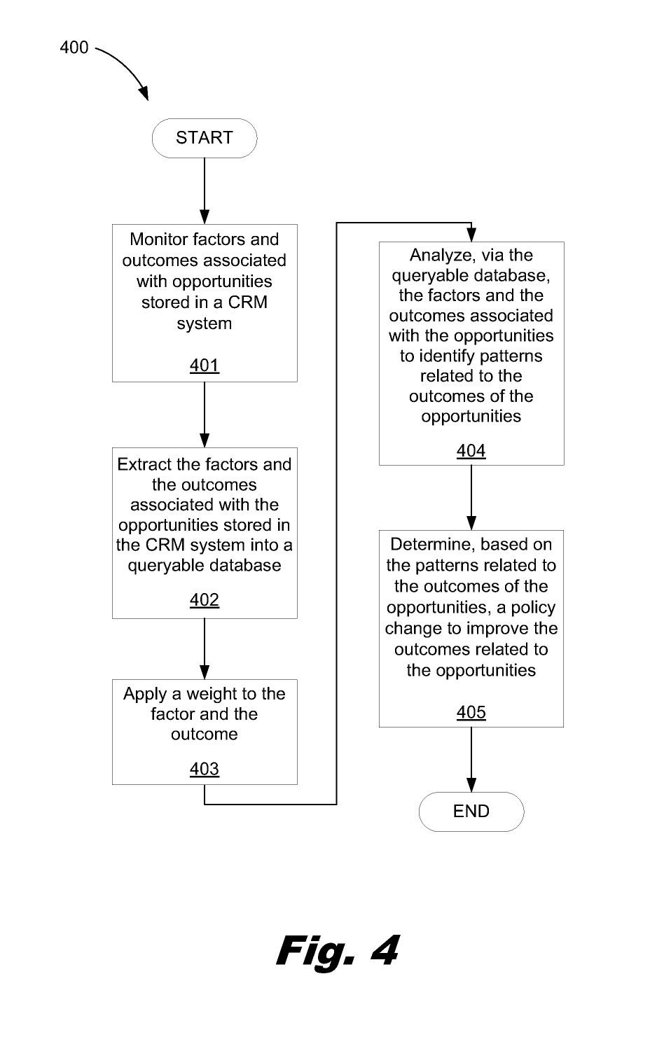

FIG. 4 is a flowchart of an example of a method for determining a policy change for an outcome related to an opportunity, according to one example of principles described herein. In one example, the method (400) may be executed by the determining system (100) of FIG. 1. In other examples, the method (400) may be executed by other systems (i.e. system 200, system 500, and system 600). In this example, the method (400) includes monitoring (401) factors and outcomes associated with opportunities stored in a CRM system, extracting (402) the factors and the outcomes associated with the opportunities stored in the CRM system into a queryable database, applying (403) a weight to the factor and the outcome, analyzing (404), via a queryable database, the factors and the outcomes associated with the opportunities to identify patterns related to the outcomes of the opportunities, and determining (405), based on the patterns related to the outcomes of the opportunities, a policy change to improve the outcomes related to the opportunities.

As mentioned above, the method (400) includes applying (403) a weight to the factor and the outcome. In one example, a weight may be a mechanism used to influence the analysis of the factors, outcomes, or combinations thereof. Further, a weight may be symbolic such as low medium, or high. In another example, a weight may be a range such as 0 to 10, 0 indicating no weight and 10 indicating the greatest weight to be applied to the factors, outcomes, or combinations thereof.

In one example, the method (400) applies a weight to a specific factor selected by a user. In yet another example, the method (400) applies a weight to a specific outcome selected by a user. In this example, the weight may be applied to a factor and/or an outcome by a user via a UI of a user device.

FIG. 5 is a diagram of an example of a determining system, according to the principles described herein. The determining system (500) includes a monitoring engine (502), an extracting engine (504), an analyzing engine (506), and a determining engine (508). In this example, the determining system (500) also includes a weighing engine (510). The engines (502, 504, 506, 508, 510) refer to a combination of hardware and program instructions to perform a designated function. Each of the engines (502, 504, 506, 508, 510) may include a processor and memory. The program instructions are stored in the memory and cause the processor to execute the designated function of the engine.

The monitoring engine (502) monitors factors and outcomes associated with opportunities stored in a CRM system. In one example, the monitoring engine (502) monitors factors associated with the opportunities such as products sold, sellers, customers, opportunity management, locations, currency, technology, timing, effort spent, costs, ROI, other factors, or combinations thereof. In one example, the monitoring engine (502) monitors the outcomes associated with the opportunities such as success based on obtained sales, failure based on missed sales, futile sales, or combinations thereof.

The extracting engine (504) extracts the factors and the outcomes associated with the opportunities stored in the CRM system into a queryable database. In one example, the extracting engine (504) extracts specific factors and specific outcomes associated with the opportunities stored in the CRM system into a queryable database. In another example, the extracting engine (504) extracts all factors and all outcomes associated with all of the opportunities stored in the CRM system into a queryable database.

The analyzing engine (506) analyzes, via a queryable database, the factors and the outcomes associated with the opportunities to identify patterns related to the outcomes of the opportunities. In one example, the analyzing engine (506) analyzes, via the queryable database, the factors and the outcomes associated with the opportunities to identify the patterns related to the outcomes of the opportunities by identifying the factors that are winning factors related to profit gains. In another example, the analyzing engine (506) analyzes, via the queryable database, the factors and the outcomes associated with the opportunities to identify the patterns related to the outcomes of the opportunities further by identifying the factors that are losing factors related to profit loss. In still another example, the analyzing engine (506) analyzes, via the queryable database, the factors and the outcomes associated with the opportunities to identify the patterns related to the outcomes of the opportunities further by identifying the factors that are expenditures without improved sales.

The determining engine (508) determines, based on the patterns related to the outcomes of the opportunities, a policy change to improve the outcomes related to the opportunities. In one example, the determining engine (508) determines, based on the patterns related to the outcomes of the opportunities, one policy change to improve the outcomes related to the opportunities. In another example, the determining engine (508) determines, based on the patterns related to the outcomes of the opportunities, several policy changes to improve the outcomes related to the opportunities.

The applying engine (510) applies a weight to the factor and the outcome. In one example, the applying engine (510) applies a weight to a specific factor and/or a specific outcome.

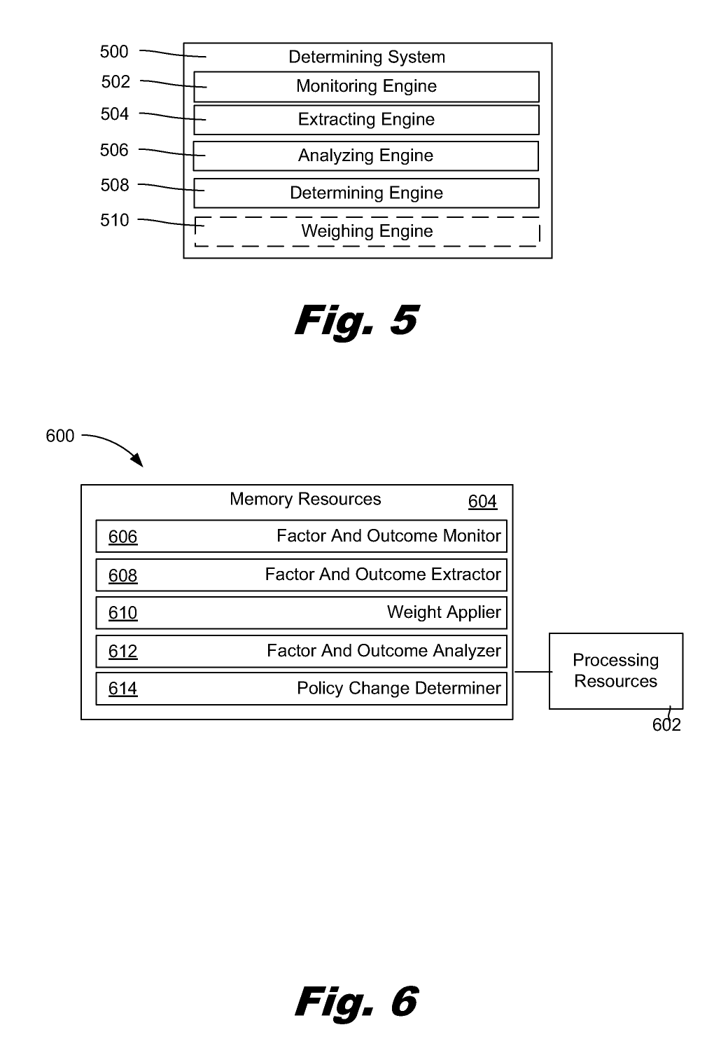

FIG. 6 is a diagram of an example of a determining system, according to the principles described herein. In this example, the determining system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the determining system (600). The programmed instructions shown stored in the memory resources (604) include a factor and outcome monitor (606), a factor and outcome extractor (608), a weight applier (610), a factor and outcome analyzer (612), and a policy changer (614).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The factor and outcome monitor (606) represents programmed instructions that, when executed, cause the processing resources (602) to monitor factors and outcomes associated with opportunities stored in a CRM system. The factor and outcome extractor (608) represents programmed instructions that, when executed, cause the processing resources (602) to extract the factors and the outcomes associated with the opportunities stored in the CRM system into a queryable database.

The weight applier (610) represents programmed instructions that, when executed, cause the processing resources (602) to apply a weight to the factors and the outcomes. The factor and outcome analyzer (612) represents programmed instructions that, when executed, cause the processing resources (602) to analyze, via the queryable database, the factors and the outcomes associated with the opportunities to identify patterns related to the outcomes of the opportunities. The policy changer (614) represents programmed instructions that, when executed, cause the processing resources (602) to determine, based on the patterns related to the outcomes of the opportunities, a policy change to improve the outcomes related to the opportunities.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the determining system (600) may be implemented on a user device, on a server, on a collection of servers, or combinations thereof.

The determining system (600) of FIG. 6 may be part of a general purpose computer. However, in alternative examples, the determining system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for determining a policy change for an outcome related to an opportunity, the method comprising:
monitoring factors and outcomes associated with opportunities stored in a customer relationship management (CRM) system;
extracting the factors and the outcomes associated with the opportunities stored in the CRM system into a queryable database;
analyzing, via the queryable database, the factors and the outcomes associated with the opportunities to identify patterns related to the outcomes of the opportunities; and
determining, based on the patterns related to the outcomes of the opportunities, a policy change to improve the outcomes related to the opportunities.

2. The method of claim 1, in which analyzing, via the queryable database, the factors and the outcomes associated with the opportunities to identify the patterns related to the outcomes of the opportunities comprises identifying the factors that are winning factors related to a profit gain.

3. The method of claim 2, in which analyzing, via the queryable database, the factors and the outcomes associated with the opportunities to identify the patterns related to the outcomes of the opportunities further comprises identifying the factors that are losing factors related to a profit loss.

4. The method of claim 3, in which analyzing, via the queryable database, the factors and the outcomes associated with the opportunities to identify the patterns related to the outcomes of the opportunities further comprises identifying the factors that are expenditures without improved sales.

5. The method of claim 1, further comprising applying a weight to the factors, the outcomes, or combinations thereof.

6. The method of claim 1, in which the factors associated with the opportunities comprise products sold, sellers, customers, opportunity management, locations, currency, technology, timing, effort spent, costs, return on investment (ROI), or combinations thereof.

7. The method of claim 1, in which the outcomes associated with the opportunities comprise success based on obtained sales, failure based on missed sales, futile sales, or combinations thereof.
